(19) United States
(12) Patent Application Publication
(10) Pub. No.: US 2008/0256305 A1
(43) Pub. Date: Oct. 16, 2008

(54) MULTIPATH ACCESSIBLE SEMICONDUCTOR MEMORY DEVICE

(75) Inventors: Jin-Hyoung KWON, Seongnam-si (KR); Han-Gu SOHN, Suwon-si (KR); Dong-Woo LEE, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/053,742

(22) Filed: Mar. 24, 2008

(30) Foreign Application Priority Data
Apr. 11, 2007 (KR) 10-2007-0035485

(51) Int. Cl. G06F 12/02

(52) U.S. Cl. 711/147; 711/E12.002

(57) ABSTRACT

A multipath accessible semiconductor memory device provides an interfacing function between multiple processors which indirectly controls a flash memory. The multipath accessible semiconductor memory device comprises a shared memory area, an internal register and a control unit. The shared memory area is accessed by first and second processors through different ports and is allocated to a portion of a memory cell array. The internal register is located outside the memory cell array and is accessed by the first and second processors. The control unit provides storage of address map data associated with the flash memory outside the shared memory area so that the first processor indirectly accesses the flash memory by using the shared memory area and the internal register even when only the second processor is coupled to the flash memory. The control unit also controls a connection path between the shared memory area and one of the first and second processors. The processors share the flash memory and a multiprocessor system is provided that has a compact size, thereby substantially reducing the cost of memory utilized within the multiprocessor system.

### CROSS-REFERENCE TO RELATED APPLICATION

This application claims the benefit of Korean Patent Application No. 10-2007-0035485 filed on Apr. 11, 2007, the disclosure of which is incorporated in its entirety by reference.

### BACKGROUND OF THE INVENTION

1. Field of the Invention

Embodiments of the invention relate to semiconductor memory devices. More particularly, embodiments of the invention relate to a multipath accessible semiconductor memory device adaptable between a plurality of processors.

2. Discussion of Related Art

In general, a semiconductor memory device having a plurality of access ports is called a multiport memory. A memory device having two access ports is called a dual-port memory. A typical dual-port memory is used as an image processing video memory having a RAM (Random Access Memory) port accessible in a random sequence and a SAM (Serial Access Memory) port accessible only in a serial sequence. A dynamic random access memory (DRAM) is configured to read from or write to a shared memory area in a memory cell array through a plurality of access ports. A DRAM that does not have a SAM port is referred to herein as a multipath accessible semiconductor memory device to distinguish it from the multiport memory device.

Multiprocessor systems have been utilized in mobile communication systems including, for example, handheld multimedia players, phones and PDAs, to obtain high speed communication. Such a system is illustrated in FIG. 1 which is a block diagram of a multiprocessor system adaptable in a mobile communication device. A first processor 101 and a second processor 201 are connected via line B3. First memory 301 and DRAM 401 are coupled with first processor 101 through a determined system bus B1. DRAM 402 and flash memory 302 are coupled with second processor 201 through a determined bus B2. First processor 101 may be dedicated to provide user application functions such as communicating data, games, etc. Second processor 201 may have a MODEM function for modulating and/or demodulating a communication signal.

Flash memories 301 and 302 may be a NOR type or NAND type. NOR flash memory or NAND flash memory is a nonvolatile memory having a transistor memory cell having a floating gate. The nonvolatile memory is adapted to store data regardless of the power state. DRAMs 401 and 402 function as main memories for data processing of corresponding processors 101 and 201. In a multi processor system, a DRAM must be assigned to each processor. Although UART, SPI, and SRAM interfaces may also be used, they can only accommodate low speed transmission. Thus, it is difficult to ensure a satisfactory data transmission speed which increases the size and cost of a corresponding memory configuration.

FIG. 2 is a multiprocessor configuration that reduces the number of DRAM memories and overall memory size while increasing data transmission speeds. DRAM 403 is connected to first and second processors 101 and 201 through bus B1 or B2. First processor 101 is coupled to flash memory 303 through bus B4, and second processor 201 is coupled to flash memory 304 through bus B5 and is connected to first processor 101 through line B3. Two ports, each connected to bus B1, B2 are adapted within DRAM 403 for access by first and second processors 101 and 201 through two paths. Such multi-port configuration differs from a general DRAM having a single port.

US Patent Application No. 2003/0093628 discloses a multiprocessor system having a shared memory area. A memory array is constructed of first, second and third portions. The first portion is accessed only by a first processor. The second portion is accessed only by a second processor and the third portion is a shared memory area accessed by the first and second processors. In this configuration, read/write paths for the first, second and third portions of the memory array are required. Typically, UART, SPI or SRAM interfaces have been used for communication between conventional processors (MODEM and application processors). Such interfaces compromise transmission speeds and increase device pin counts. Processors that share a memory area outside the allocated DRAM require transmission interfacing operation between processors through, for example, line B3. In addition, a flash memory is employed for each processor which further complicates the system while adding cost. Again, this interfacing compromises transmission speeds and increases device pin counts. As data traffic increases in three-dimensional game or image communications (HDPDA, wibro, etc.), high speed interfaces between multi processors is needed. Accordingly, in multiprocessor systems there is a need to share one DRAM and one flash memory and to interface between a particular processor using a multipath accessible DRAM that is not directly connected to a flash memory, but that can indirectly access the flash memory through the DRAM.

### SUMMARY OF THE INVENTION

Exemplary embodiments of the present invention are directed to a semiconductor memory device having an interfacing function between multiple processors capable of indirectly controlling a flash memory. In an exemplary embodiment, the semiconductor memory device includes a shared memory area accessed by first and second processors via different input/output ports. The shared memory area is allocated to a portion of a memory cell array. A flash memory is located outside the shared memory area and is coupled to the second processor. An internal register located outside the memory cell array is accessed by the first and second processors. A control unit is configured to control the storage of address map data associated with the flash memory such that the first processor indirectly accesses the flash memory by using the shared memory area and the internal register even when only the second processor is coupled to the flash memory. The control unit is further configured to operationally connect the shared memory area to one of the first and second processors.

### BRIEF DESCRIPTION OF THE DRAWINGS

FIG. 1 is a block diagram of multiprocessor system applicable to a mobile communication device according to conventional art;

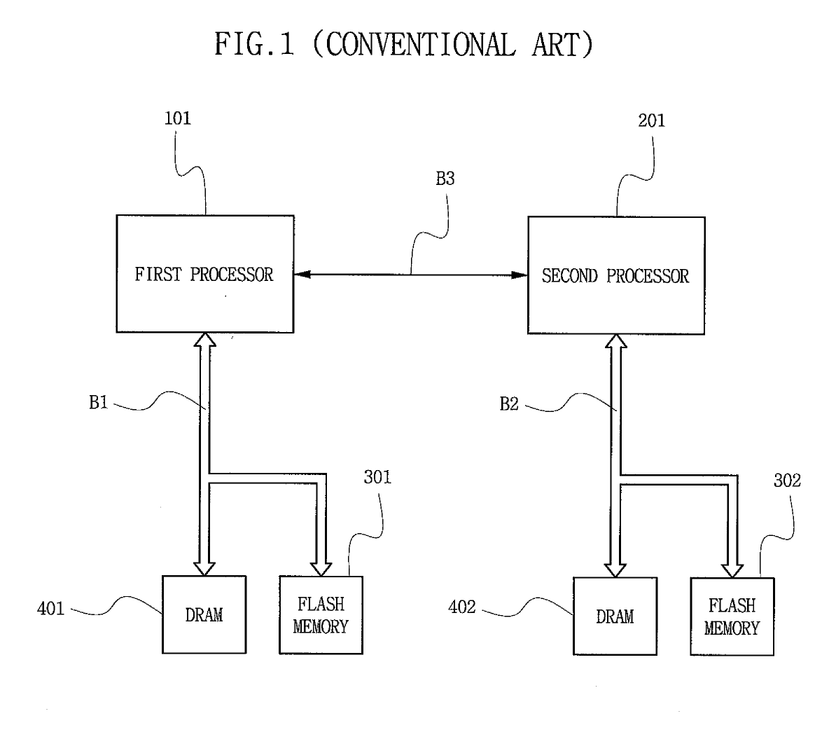

FIG. 2 is a block diagram of multiprocessor system according to conventional art;

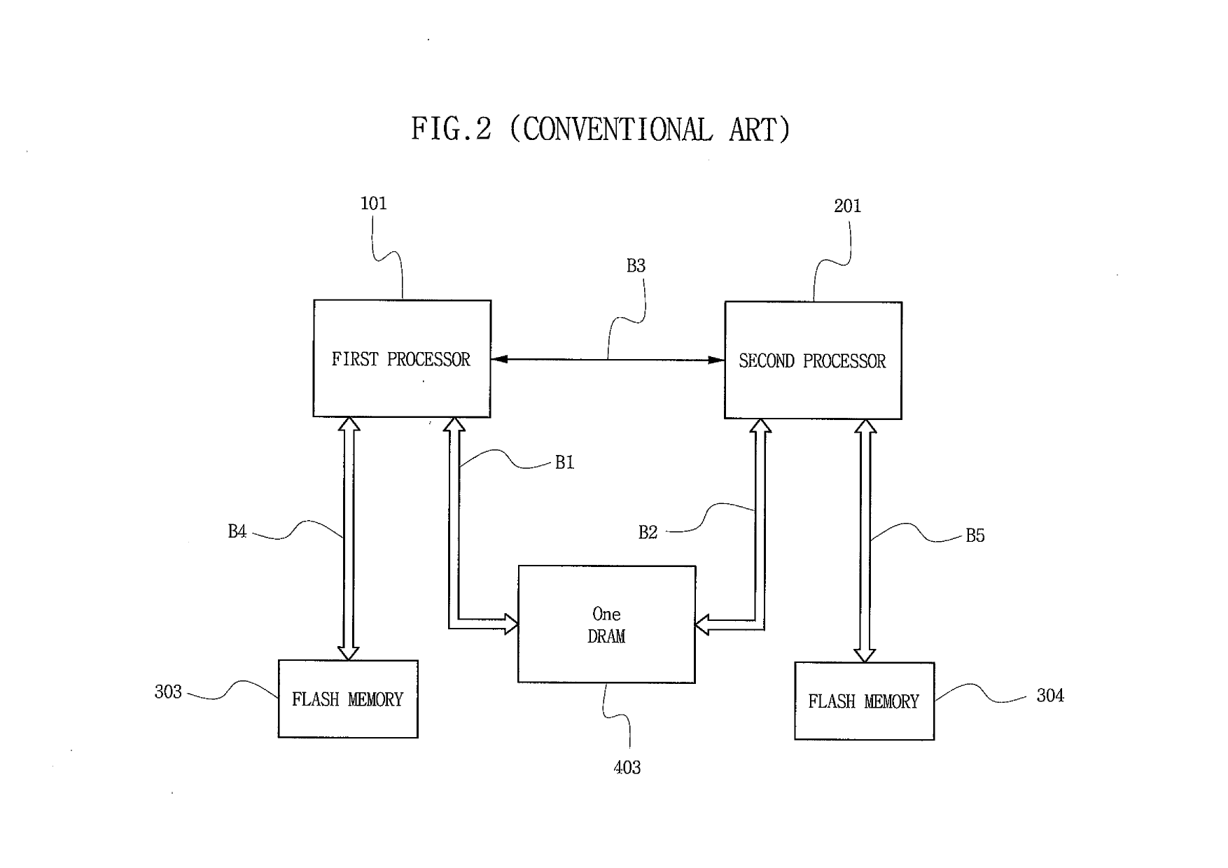

FIG. 3 is a block diagram of multiprocessor system having a multipath accessible DRAM in accordance with the present invention;

FIG. 4 is a block diagram of multipath accessible DRAM shown in FIG. 3;

FIG. 5 illustrates an address allocation to memory areas and an internal register referred to in FIG. 4;

FIG. 6 is an address map table illustrating a matching example between logical addresses and physical addresses for flash memory of FIG. 3;

FIG. 7 is a block diagram of a circuit related to a multipath access of a shared memory area and an internal register referred to in FIG. 4;

FIG. 8 illustrates in detail the circuit of FIG. 7;

FIG. 9 is a circuit diagram illustrating an example of control unit referred to in FIGS. 4, 7 and 8;

FIG. 9A is a timing diagram for signals PA and PB.

FIG. 10 is a circuit diagram illustrating an example of address multiplexer referred to in FIGS. 7 and 8;

FIG. 11 is a flowchart for write operation of processors to write data to a flash memory through a multipath accessible DRAM of FIG. 4; and

FIG. 12 is a flowchart for read operation of processors to read data from a flash memory through a multipath accessible DRAM of FIG. 4.

### DETAILED DESCRIPTION OF EMBODIMENTS OF THE INVENTION

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

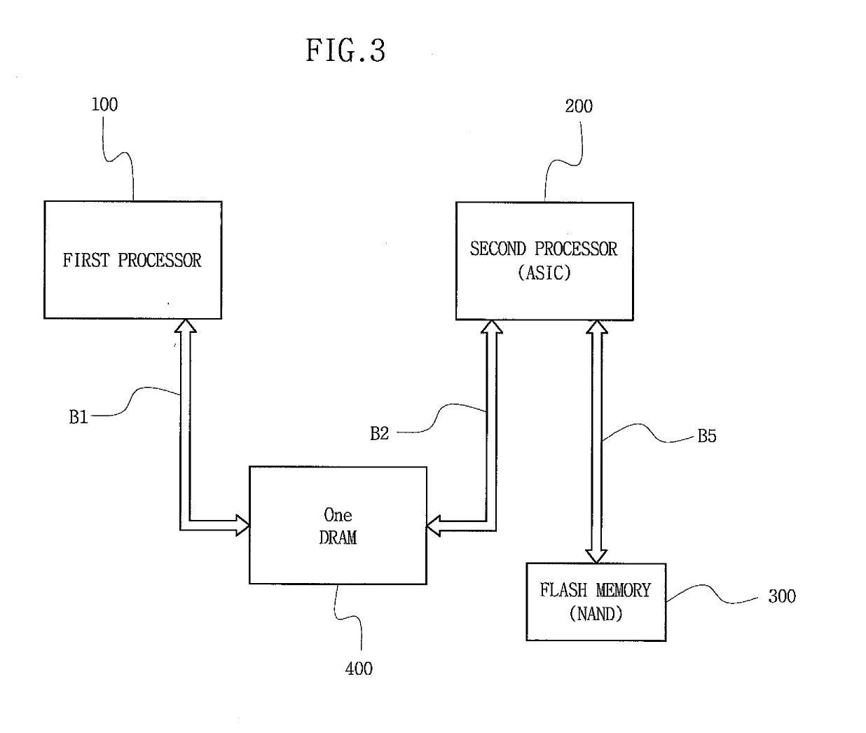

FIG. 3 is a block diagram of multiprocessor system having a multipath accessible DRAM with a shared use of flash memory according to an embodiment of the invention. A multipath accessible DRAM 400 is coupled between first processor 100 and second processor 200. First processor 100 may be used for application processes and second processor 200 may be an ASIC (Application Specific Integrated Circuit). DRAM 400 may also be, for example, a static random access memory or nonvolatile memory, etc. Flash memory 300 is coupled to second processor 200. First processor 100 is coupled to DRAM 400 via bus B1 and second processor 200 is coupled to DRAM 400 via bus B2. In an initial system booting, address map data of the flash memory is stored via a table in a shared memory area of DRAM 400. First processor 100 communicates with second processor 200 via DRAM 400 without the use of external interfacing, thereby indirectly accessing flash memory 300. In this manner, when first processor 100 is coupled to DRAM 400, first processor 100 indirectly accesses flash memory 300 which is connected to second processor 200. Address map data of the flash memory is passed through a DRAM interface and stored in shared memory area of DRAM 400. The multiprocessor system of FIG. 3 may be, for example, a portable computing device or mobile communication device such as cellular phones, two-way radio communication systems, simplex pagers, duplex pagers, etc. Although only first processor 100 and second processor 200 are shown, the number of processors utilized may be three or more. The processor may be a CPU, ASIC, a digital signal processor, a micro controller, a reduced command set computer, a complex command set computer, or a combination thereof.

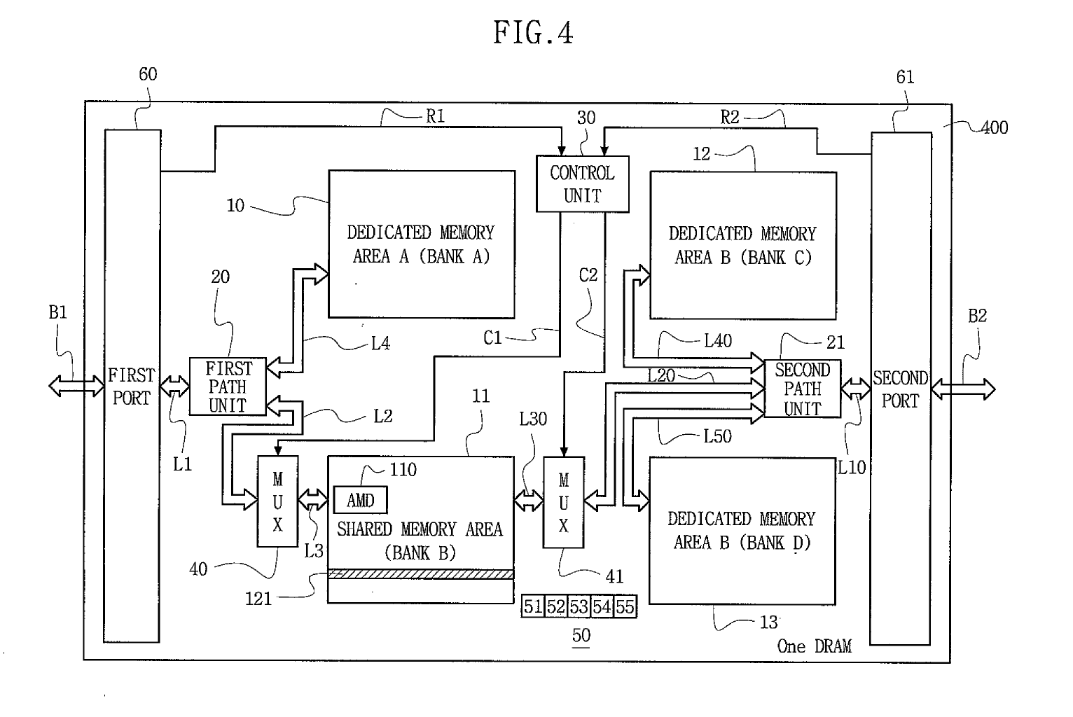

Referring to FIG. 4, an internal register 50 functions as an interface unit within the DRAM 400 to allow communication between processors 100 and 200. Internal register 50 includes a semaphore and mailbox areas, and accommodates data communication through shared memory area 11 which is commonly accessible by processors 100 and 200. A multipath accessible DRAM 400 includes four memory areas 10, 11, 12 and 13 which constitute a memory cell array, and an internal register 50 disposed outside the memory cell array. First and second path units 20 and 21, multiplexers 40 and 41, and control unit 30 are also disposed outside the memory cell array. DRAM 400 may have two independent ports. For example, first port 60 is connected to bus B1 and second port 61 is connected to bus B2. Buses B1 and B2 may be a general-purpose input/output (GIPO) line.

Dedicated memory area A (10) is accessed by first processor 100 via first port 60. Dedicated memory area B including bank C (12) and bank D (13) is accessed by second processor 200 via second port 61. In addition, shared memory area 11 is accessed by first and second processors 100 and 200 via first and second ports 60 and 61. Memory bank B (11) is allocated as the shared memory area and banks A (10), C (12) and D (13) are allocated as the dedicated memory area for access by each corresponding processor. Each of the four memory areas 10-13 may be, for example, 64 Mb, 128 Mb, 256 Mb, 512 Mb or 1024 Mb.

A storage table area 110 is configured within shared memory area 11 to store address map data of flash memory 300. The address map data represents information of a logical address of flash memory 300 corresponding to a physical address. Internal register 50 functions as an interface unit between first and second processors 100 and 200 and may be a flip-flop, a data latch or SRAM cell. Internal register 50 may be classified as a semaphore area 51, a first mailbox area (mail box A to B: 52), a second mailbox area (mail box B to A: 53), a check (CHK) bit area 54, and a reserve area 55. Areas 51-55 may be enabled in common by a specific row address and are individually accessed by an applied column address. For example, when a row address 1FFF800h˜1FFFFFFh corresponding to a specific row area 121 of shared memory area 11 is accessed, area 121 of the shared memory area is disabled and internal register 50 is enabled. In semaphore area 51, control permission for shared memory area 11 is written. In first 52 and second 53 mailbox areas, a message given to a counter processor is written according to a predetermined transmission direction. This written message may be, for example, a permission request, transmission of data indicating a logical/physical address of flash memory or data size, or an address of shared memory to store data.

Control unit 30 initiates a control command to store address map data of flash memory 300 in storage table area 110. This control command allows first processor 100 to indirectly access flash memory 300 by utilizing the shared memory area 11 and internal register 50. This is done even when only second processor 200 is coupled to flash memory 300 and provides a path to operationally connect shared memory area 11 to one of the first 100 and second processors 200. A signal line R1 is connected from first port 60 to control unit 30 to transfer a first external signal applied via bus B1 from first processor 100. A signal line R2 is connected from second port 61 to control unit 30 to transfer a second external signal applied via bus B2 from second processor 200. First and second external signals may include a row address strobe signal RASB, write enable signal WEB and bank selection address BA which are individually applied via first and second ports 60 and 61. Signal lines C1 and C2 each transfer path decision signals to operationally connect shared memory area 11 to first port 61 or second port 62.

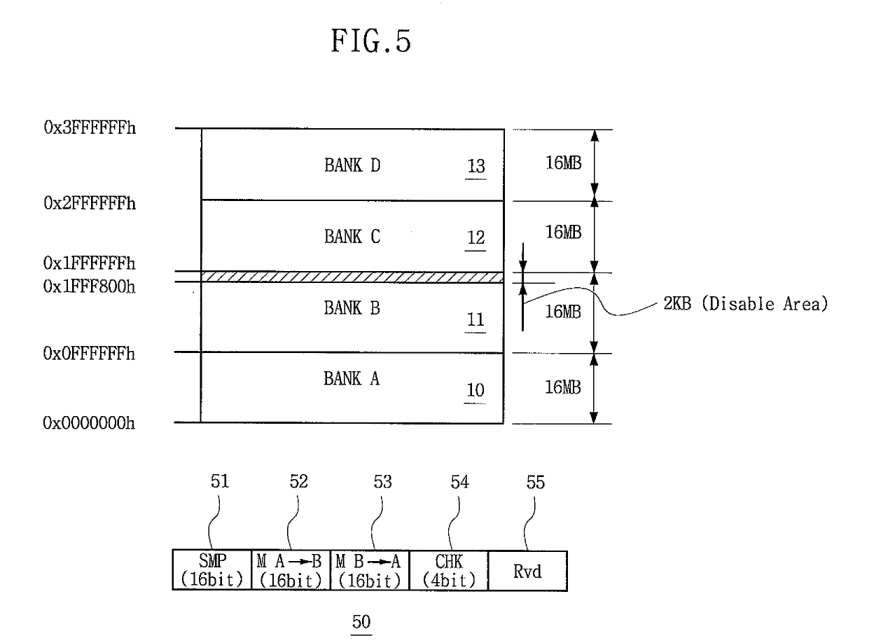

FIG. 5 provides an address allocation corresponding to memory areas and the internal register of FIG. 4. For example, when each bank 10-13 has a capacity of 16 mega bits, 2 kilobits of memory in bank B is determined as a disable area. That is, a specific row address (1FFF800h˜1FFFFFFh, 2 KB size=1 row size) enabling one optional row of the shared memory area 11 is changeably allocated to internal register 50 as an interface unit. When the specific row address (1FFF800h˜1FFFFFFh) is applied, a specific word line 121 corresponding to the shared memory area 11 is disabled while the internal register is enabled. As a result, the semaphore area and mailbox areas 52 and 53 are accessed by the direct address mapping method. The mapping to the DRAM internal register is performed by decoding a command associated with a corresponding disabled address. In this manner, a memory controller of a chip set produces a command for this area through the same method as used to access a memory cell, thereby preventing precharge error associated with a controller employing an open policy Semaphore area 51, first mailbox area 52 and second mailbox area 53 may each have, for example, 16 bits of memory, and the check (CHK) bit area 54 may have 4 bits.

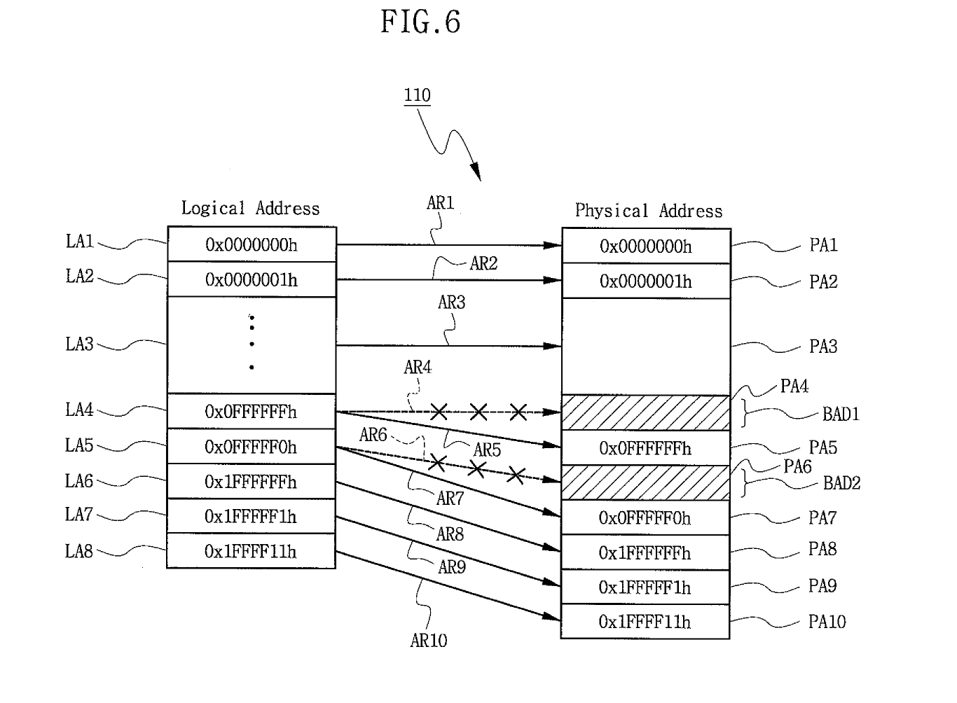

FIG. 6 is an address map table illustrating the matching of physical addresses and logical addresses of flash memory 300. Address area LA1-LA8 indicates a logical address which is matched on a one to one basis with physical address area PA1-PA10 If a bad sector is located in the flash memory, a logical address is not matched to a physical address. For example, arrow AR4 connects logical address area LA4 with physical address area PA4. If the memory cell corresponding to the selected address is defective (BAD1), the logical address is matched to a physical address area PA5 as indicated by arrow AR5. As a result, when a processor accesses the memory area having logical address 0x0FFFFFFh, the processor accesses physical address area PA5 of the flash memory. When first processor 100 accesses a logical address of flash memory 300, the first processor may write the physical address corresponding to the logical address or the logical address to internal register 50. In the former case, the first processor 100 may refer to a storage table area 110 of share memory area 11. In the latter case, the second processor 200 may refer to storage table area 110. Address map data of flash memory 300 is stored in table area 110 and is data loaded by second processor 200 in an initial system boot.

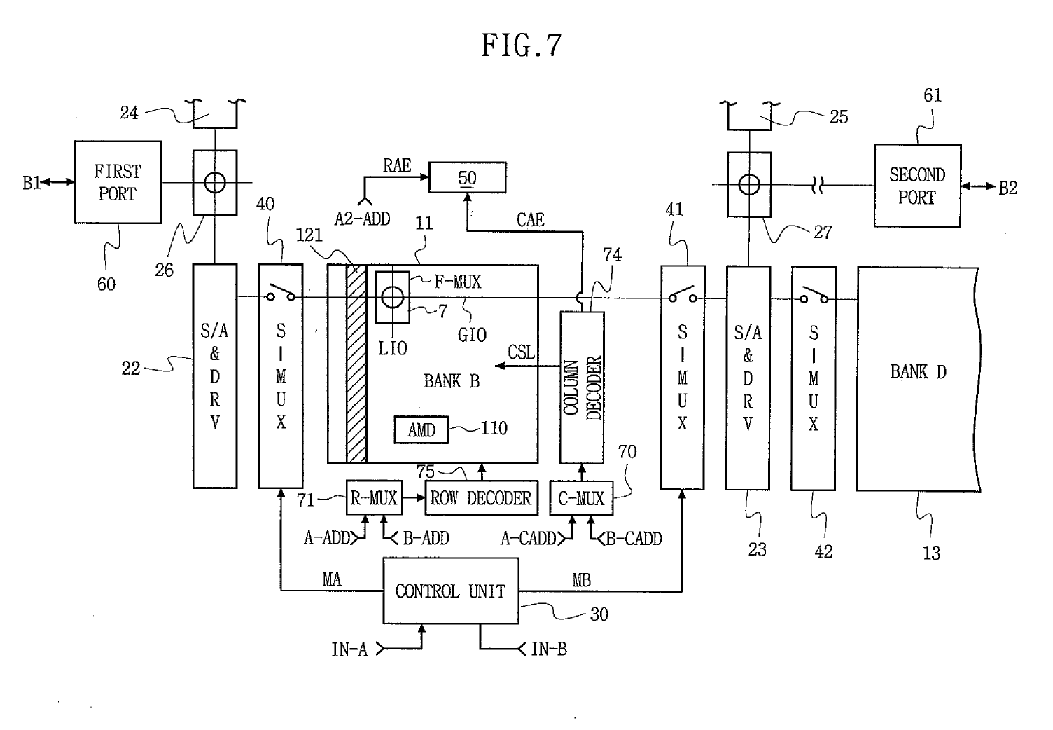

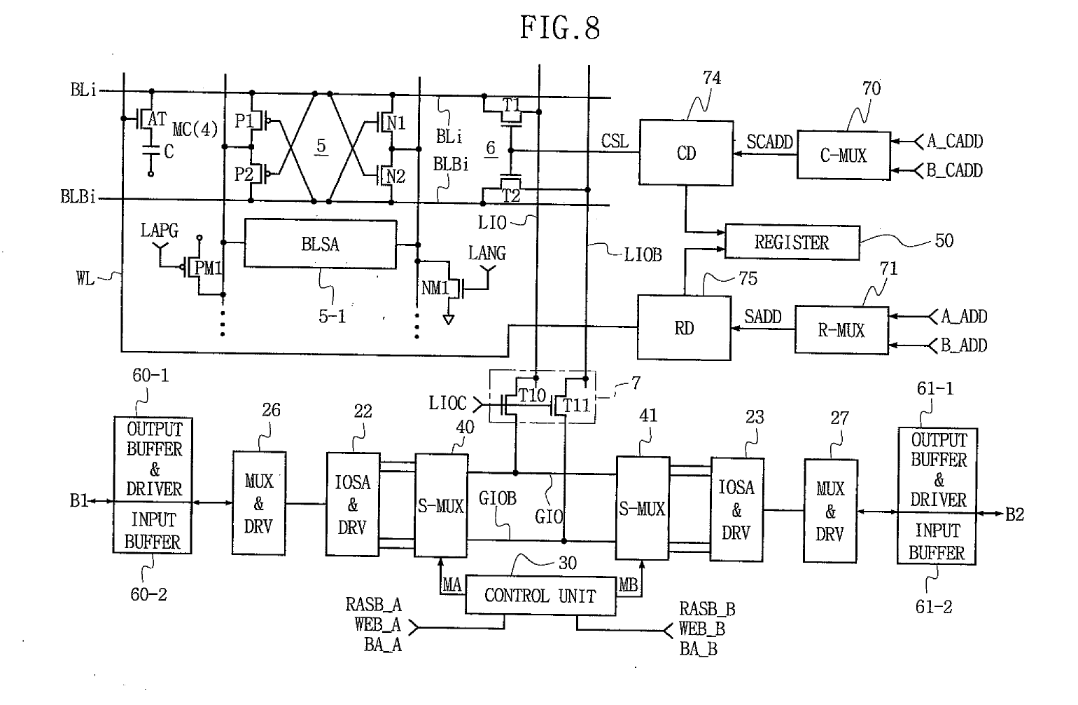

FIG. 8 illustrates the multipath access circuit of FIG. 7 in detail. Multiplexers 40 and 41 are symmetrically disposed and connected to control unit 30. Input/output sense amplifier and driver 22 and an input/output sense amplifier and driver 23 are symmetrically disposed and connected to multiplexers 40 and 41 respectively. In shared memory area 11, DRAM cell 4 is constructed of one access transistor AT and storage capacitor C to form a memory unit. DRAM cell 4 is coupled to intersections of a plurality of word lines and a plurality of bit lines, thus forming a matrix bank array. Word line WL is disposed between the gate of access transistor AT and row decoder 75. Row decoder 75 applies a row decoding signal to word line WL and register 50 in response to a selected row address SADD of row address multiplexer 71. Bit line BLi constituting a bit line pair is coupled to the drain of access transistor AT and column selection transistor T1. Complementary bit line BLBi is coupled to column selection transistor T2. PMOS transistors P1 and P2 and NMOS transistors N1 and N2 are coupled to bit line pair BLI, BLBI and define a bit line sense amplifier. Sense amplifier driving transistors PM1 and NM1 each receive drive signal LAPG and LANG to drive the bit line sense amplifier. A column selection gate 6 constructed of column selection transistors T1 and T2 is connected to column selection line CSL to transfer a column decoding signal of column decoder 74. Column decoder 74 applies a column decoding signal to the column selection line and register 50 in response to a column selection address SCADD of column address multiplexer 70.

A local input/output line LIO (shown in FIG. 7) corresponds to local input/output line pair LIO connected to transistor T10 similar to line LIOB of FIG. 8. Transistors T10 and T11 define a first multiplexer 7:F-MUX. When these transistors are turned on by local input/output line control signal LIOC, local input/output line pair LIO, LIOB is logically connected to global input/output line pair GIO, GIOB. In a data read mode, data appearing on the local input/output line pair LIO, LIOB is transferred to the global input/output line pair GIO, GIOB. In a data write mode, write data applied to the global input/output line pair GIO, GIOB is transferred to the local input/output line pair LIO, LIOB. The local input/output line control signal LIOC may be a signal generated in response to a decoding signal output from row decoder 75.

When path decision signal MA output from control unit 30 has an active state, read data transferred to global input/output line pair GIO, GIOB is transferred to input/output sense amplifier and driver 22 via second multiplexer 40. Input/output sense amplifier and driver 22 amplifies data having a weakened level according to the transfer procedures via the data path. Read data output from input/output sense amplifier and driver 22 is transferred to first port 60 via multiplexer and driver 26. At this time, the path decision signal MB is in an inactive state and second multiplexer 41 is disabled. Thus, the access operation of second processor 200 to shared memory area 11 is intercepted. In this manner, second processor 200 can access dedicated memory areas 12 and 13 via second port 61, but can not access shared memory area 11. When path decision signal MA output from control unit 30 is under the active state, write data applied via first port 60 is transferred to the global input/output line pair GIO, GIOB passing through multiplexer and driver 26, input/output sense amplifier and driver 22 and second multiplexer 40. When first multiplexer 7:F-MUX is activated, write data is transferred to local input/output line pair LIO, LIOB and is stored in selected memory cell 4. Output buffer and driver 60-1 and input buffer 60-2 may correspond to or be included in first port 60.

Two input/output sense amplifier and drivers 22 and 23 are disposed in shared memory area 11. Multiplexers 40 and 41 have mutually complementary operations to prevent the two processors from simultaneously accessing data from shared memory area 11. First processor 100 and second processor 200 commonly use the circuit devices and circuit lines existing between global input/output line pair GIO, GIOB to access memory cell 4. In particular, local input/output line pair LIO, LIOB are operationally connected to the global input/output line pair GIO, GIOB. Bit line pair BL, BLB is operationally connected to the local input/output line pair LIO, LIOB via column selection signal CSL. Bit line sense amplifier 5 installed on the bit line pair BL, BLB senses and amplifies data from the memory cell 4 via access transistor AT connected to bit line BL. An input/output sense amplifier and driver 24 is dedicated to memory area A (bank A) 10 and an input/output sense amplifier and driver 25 is dedicated to memory area B (bank B) 12.

As described above, by utilizing internal register 50 functioning as an interface unit, processors 100 and 200 perform data communication through commonly accessible shared memory area 11. Processor 100 indirectly accesses flash memory 300 which is connected to processor 200. In this manner, data communication between processors can be performed through the shared memory area without an external interface and a single flash memory may be commonly used in a multiprocessor system. In addition, when interfacing between processors via the interior of DRAM memory, a plurality of processors can access the allocated shared memory area at high speeds, thereby improving data transmission and reducing system size.

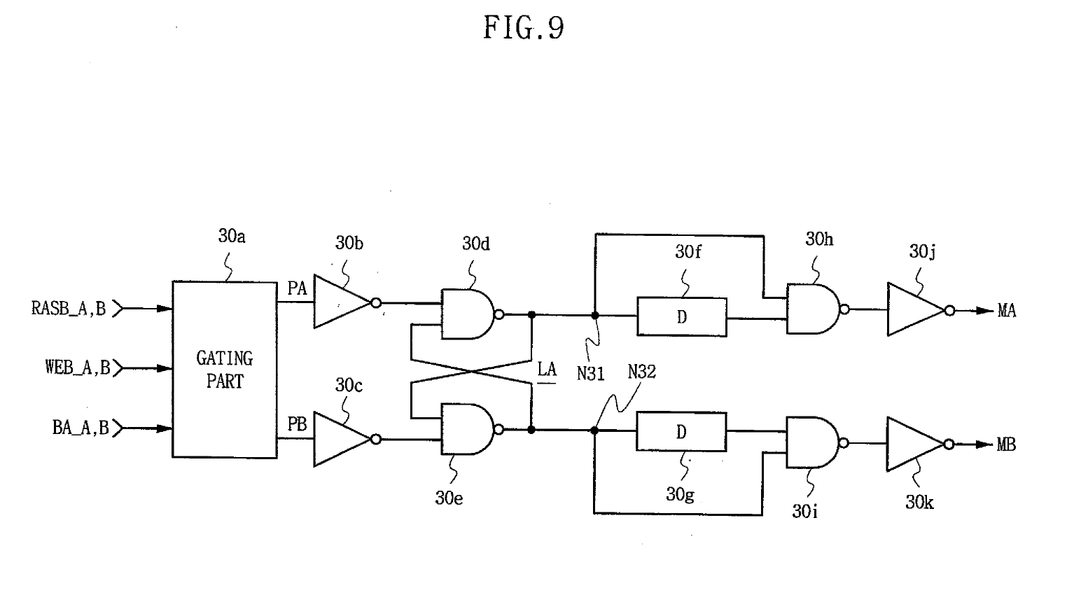

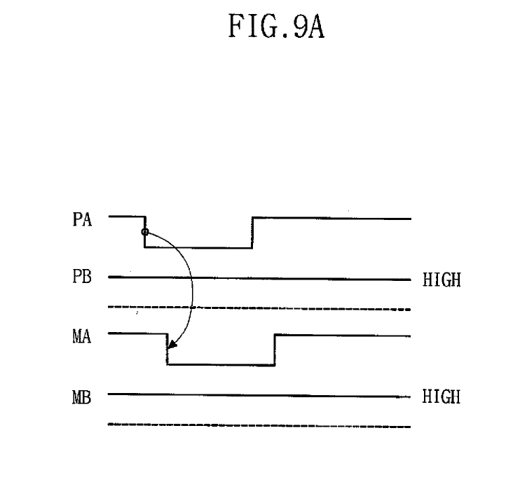

FIG. 9 illustrates an example of control unit 30 having a gating part 30a constructed of a plurality of logic gates. Gating part 30a receives row address strobe signal RASB_A,B, write enable signal WEB_A,B and bank selection address BA_A,B supplied through first port 60 and second port 61. Gating part 30a generates gating signals PA and PB having timings illustrated in FIG. 9A. When gating signal PA is output with a logic low, path decision signal MA is output as a logic low. When gating signal PA is output as a logic low, gating signal PB is maintained as a logic high and path decision signal MB is output as a logic high. When row address strobe signal RASB is input via one of the ports 60 or 61, the gating part 30a accommodates shared memory area 11. If row address strobe signal RASB is applied simultaneously through ports 60 and 61, the processor having a priority within the system for access to shared memory area 11. Control unit 30 comprises inverters 30b, 30c, 30h and 30i, NAND gates 30d and 30e, delay devices 30f and 30g, and NAND gates 30h and 30i. Path decision signal MA initiates the delay (by a specified time) and latching of gating signal PA. Similarly, path decision signal MB initiates the delay (by a specified time) and latching of gating signal PB.

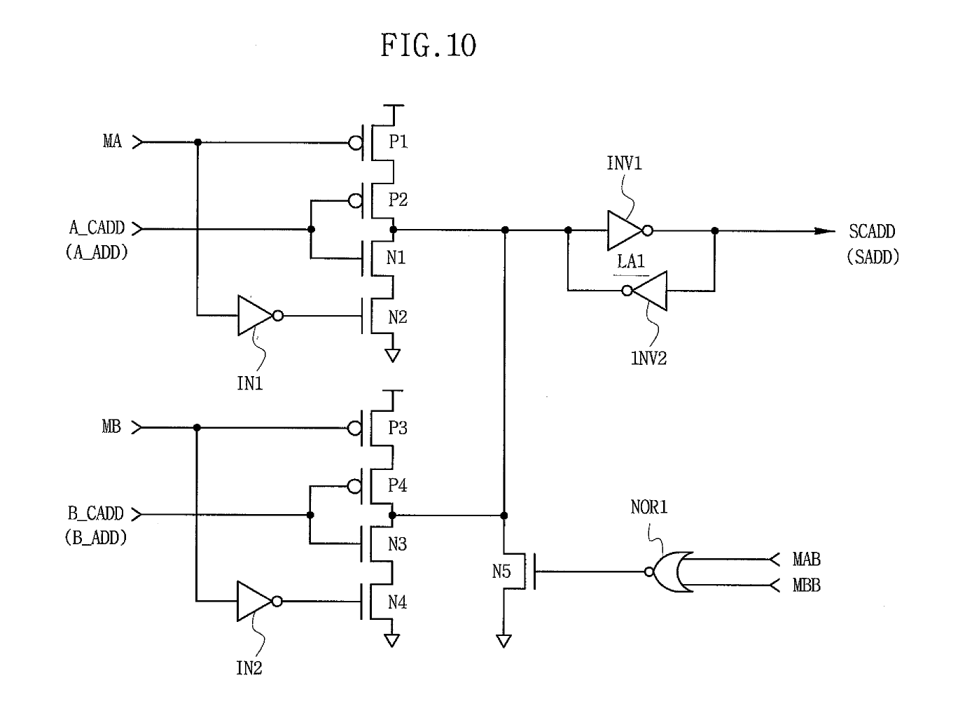

FIG. 10 is a circuit diagram illustrating an example of address multiplexer defined by row address multiplexer 71 or column address multiplexer 70 shown in FIGS. 7 and 8 depending on the type of input signal. Column address multiplexer 70 comprises clocked CMOS inverters constructed of PMOS transistors P1-P4, NMOS transistors N1-N4, and an inverter latch LA1 constructed of inverters INV1 and INV2. Two column addresses A_CADD and B_CADD are supplied through two input terminals to column address multiplexer 70 and one of these two inputs is selected by a logic state of patch decision signal MA, MB and outputted as a selection column address SCADD. NMOS transistor N5 and NOR gate NOR1 are adapted to form a discharge path between an input terminal of inverter latch LA1 and ground. Inverters IN1 and IN2 are adapted invert the logic state of patch decision signal MA, MB.

For example, when patch decision signal MA is applied with a logic low level, column address A_CADD applied via first port 60 is inverted through the inverter constructed of PMOS transistor P2 and NMOS transistor N1. This signal is inverted again through inverter INV1 and is output as selection column address SCADD. While path decision signal MB is applied with a logic high level, column address B_CADD, which can be applied through second port 61, can not be provided to an input terminal of the latch LA1 since an inverter constructed of PMOS transistor P4 and NMOS transistor N3 is in an inactive state. As a result, column address B_CADD is not output as selection column address SCADD. When an output of NOR gate NOR1 is a logic high, NMOS transistor N5 is turned on and a logic level latched to latch LA1 is reset to a logic low.

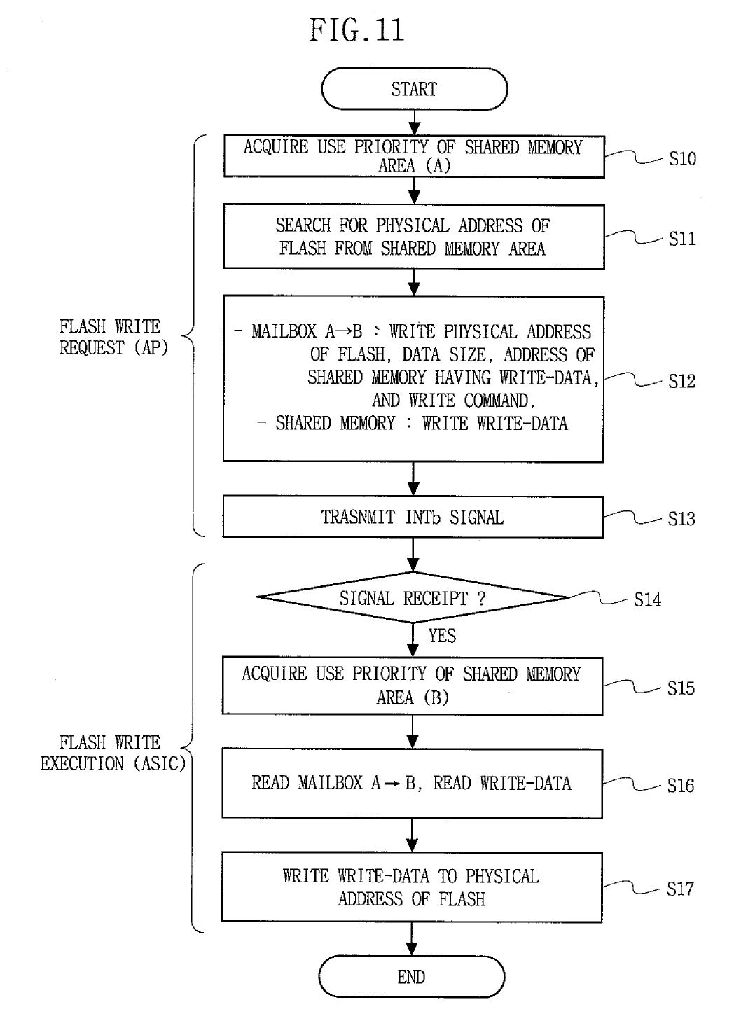

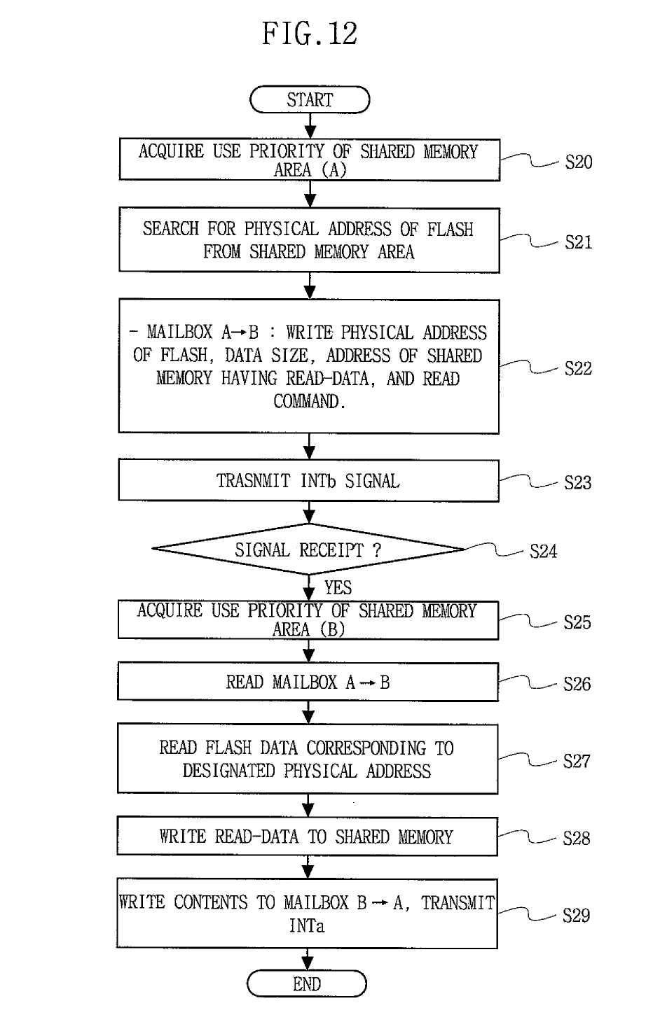

FIG. 11 is a flowchart illustrating a write operation of processors 100 and 200 to write data to flash memory 300 through the multipath accessible DRAM 400 shown in FIG. 4. Conversely, FIG. 12 is a flowchart illustrating a read operation of processors 100 and 200 to read data from flash memory 300 through the multipath accessible DRAM 400 of FIG. 4. Although first processor 100 may be configured to accommodate only logic addresses of flash memory in a write operation, it may also search for a physical address corresponding to a particular logic address. When first processor 100 deals with only a logical address of flash memory 300, second processor 200 must search for the physical address corresponding to the logical address. First, in an initial booting of the multiprocessor system shown in FIG. 3, address map data (AMD) related to logical address of flash memory 300 and its corresponding physical address is loaded in storage table area 110 of shared memory area through use of the second processor 200. Semaphore area 51 and second mailbox 53, within the internal register 50, may be configured so that second processor 200 obtains control permission. The acquirement of control permission is needed to use the shared memory area 11 as a common resource of processors without a conflict.

Generally, in an initialization step of a typical DRAM memory, auto refresh is performed twice and then a mode register set (MRS) signal is set. However, in this embodiment, the MRS signal is set before an initialization of the memory is complete. This prevents auto refresh from being performed. In order to perform the auto refresh operation, a control permission of shared memory area 11 may be allocated as the default for processor 200. When processor 100 attempts to use shared memory area 11 without permission, a signal requesting permission is sent to the processor 200 through first mailbox 52. First processor 100 periodically monitors semaphore area 51 in order to check whether control permission is obtained. When second processor 200 completes execution, semaphore area 51 is released. Thus, first processor 100 clarifies the release of semaphore area and obtains access permission to shared memory area 11 as the common resource as shown in step S10 of FIG. 11.

In step S11, first processor 100 searches for a physical address corresponding to a logical address to which write data will be written referring to storage table area 110 of the shared memory area 11. For example, by accessing the address map table as illustrated in FIG. 6, first processor 100 searches for a physical address corresponding to the logical address of flash memory 300. In step S12, first processor 100 writes, physical address of flash memory, write data size, address of shared memory area 11 (where write data is stored), and the write command in first mailbox area 52. First processor 100 also writes the write data to shared memory area 11. In step S13, first processor 100 transmits an interrupt signal INTb. Data, which appeared as a logic ‘1’ in semaphore area 51 is changed to logic ‘0’ so that second processor 200 recognizes that first processor 100 supplied access permission. Because other areas of internal register 50 have a flip-flop or latch type storage cell, precharge is not needed.

Second processor 200, which periodically checks semaphore area 51, determines whether the transmit INTb signal is received at step S14. If signal INTB is received, second processor has access permission after reading flag data of semaphore area 51 at step S15. Second processor 200 acquires a use priority for shared memory area 11 and reads the contents written to the first mailbox area 52 in step S16. In step S17, the data written to shared memory area 11 is read and the data is written to a corresponding physical address of the flash memory 300 based on the contents of data read from first mailbox area 52. The write operation of flash memory 300 in step S17, is performed by applying a high voltage of about 12 to 18 volts to a memory cell transistor having a floating gate to generate an F-N tunneling operation. This write operation is typical for NAND or NOR flash memories.

When first processor 100 only handles the logical address of flash memory in the write operation, step S11 is skipped and the logical address of the flash memory is written in first mailbox area 52 in step S12. Second processor 200 searches for the physical address corresponding to the logical address based on the information from storage table area 110. Second processor 200 directly searches for an address map table allocated to the interior of flash memory 300.

FIG. 12 illustrates the operation of reading data from flash memory 300 through first processor 100. Similar to the write operation, first processor 100 may process the logical address of the flash memory during the read operation, but may also search for the physical address corresponding to the logical address. First processor 100 acquires access permission for shared memory area 11 in step S20. In step S21, first processor 100 searches for the physical address corresponding to the logical address referring to storage table area 110 of shared memory area 11. In step S22, first processor 100 writes a physical address of the flash memory, the physical address of the flash memory, the read data size, an address of the shared memory area 11 (into which read data will be stored), and a read command in first mailbox area 52. First processor 100 transmits an interrupt signal INTb in step S23. Data having a logic high ‘1’ in semaphore area 51 is changed to a logic low ‘0’ so that second processor 200 recognizes that first processor 100 has given access permission to the second processor.

Second processor 200, which periodically checks semaphore area 51, determines whether the transmit INTb signal is received at step S24. If signal INTB is received, second processor has access permission after reading flag data of semaphore area 51 at step S25. Second processor 200 acquires a use priority for shared memory area 11 and reads the contents written to first mailbox area 52 in step S26. In step S27, second processor 200 accesses flash memory 300 and reads data stored with the corresponding physical address designated by first processor 100 based on the contents read from first mailbox area 52. The data read is then written to a designated address of shared memory area 11 in step S28. In step S29, second processor 200 writes information to second mailbox area 53 and transmits the INTa signal. First processor 100 checks and clarifies semaphore area 51 and second mailbox area 53 and reads the data of flash memory 300 that the ASIC (Application Specific Integrated Circuit) 200 wrote to shared memory area 11 of DRAM 400.

The read operation of flash memory 300 is performed by applying a voltage lower than the voltage associated with the write operation to a memory cell transistor. This difference in voltage levels provides a means to determine whether a selected memory cell is an on-cell or off-cell. Although the method described with reference to FIG. 12 describes first processor 100 as a main searcher for address map data (AMD), first processor 100 may also be configured to process the logical address operation and second processor 200 may be used to search for the physical address.

Flash memory 300 may also be a nonvolatile semiconductor memory such as a PRAM, RRAM, or MRAM etc. In addition, the four memory areas described above may be configured to have two memory areas as shared memory and two as dedicated memory, or all four memory areas may be configured as shared memory areas. The present embodiment has been described as including two processors. However, when three or more processors are employed, three or more corresponding ports may be adapted in one DRAM and one of three processors may be designated to access a predetermined shared memory. Furthermore, although DRAM is described above as an example, without limiting to that a technical spirit of the invention may be extended to a static random access memory or nonvolatile memory etc.

Although the present invention has been described in connection with the embodiment of the present invention illustrated in the accompanying drawings, it is not limited thereto. It will be apparent to those skilled in the art that various substitutions, modifications and changes may be made thereto without departing from the scope and spirit of the invention.

What is claimed is:

1. A semiconductor memory device comprising:
a shared memory area accessed by first and second processors via different input/output ports, said shared memory area allocated to a portion of a memory cell array;
an internal register located outside the memory cell array and accessed by the first and second processors; and
a control unit configured to control the storage of address map data associated with a flash memory such that the first processor indirectly accesses the flash memory by using the shared memory area and the internal register even when only the second processor is coupled to the flash memory, said control unit further configured to operationally connect the shared memory area to one of the first and second processors.

2. The device of claim 1 wherein the memory cell array has dedicated memory areas accessible exclusively by the either the first or second processor.

3. The device of claim 1 wherein the internal register is accessed substitutively corresponding to a specific address of the share memory area.

4. The device of claim 1 wherein the address map data comprises a logical address of the flash memory and a physical address mapped to the logical address.

5. The device of claim 3 wherein the internal register comprises a semaphore area and mailbox areas distinguished by a column address.

6. The device of claim 1 wherein the shared memory area is formed of DRAM cells and the internal register is constructed of a flip-flop.

7. The device of claim 4 wherein the first processor applies the physical address corresponding to the logical address of the flash memory to the internal register when accessing the flash memory.

8. The device of claim 4 wherein the first processor applies the logical address of the flash memory intact to the internal register when accessing the flash memory.

9. The device of claim 5 further comprising a transmission mailbox area within said mailbox areas, said first processor is configured to write write-data to the shared memory area, first processor further configured to store the physical address of the flash memory, a data size associated with the write-data, an address of the shared memory area where the write-data is written, and a write command to said transmission mailbox area.

10. The device of claim 9, wherein the second processor acquires a use priority for the shared memory area, and accesses the transmission mailbox to read the write-data from the shared memory area, said second processor writing the write-data to the physical address of the flash memory.

11. A semiconductor memory for use with a first and second processor, said second processor being coupled to a first flash memory device, said semiconductor memory comprising:
a shared memory area defined by a memory bank of a memory cell array, said shared memory area selectively accessed by the first and second processors via corresponding input/output ports, said shared memory array configured to store address map data associated with said flash memory device;
an interfacing unit located outside the memory cell array and selectively accessed by the first and second processors, said interfacing unit configured to provide a specific address of the shared memory area so that the first processor accesses the flash memory through the shared memory area; and
a control unit configured to form a data access path between a first of said input ports and the shared memory area in response to an external signal applied from the first and second processors.

12. The device of claim 11 wherein the interfacing unit comprises:
a semaphore area; and
first and second mailbox areas distinguished by a column address.

13. The device of claim 12 wherein the memory cell array includes dedicated memory areas individually accessed by the first and second processors.

14. The device of claim 13 wherein the address map data contains a logical address associated with the flash memory and a physical address mapped to the logical address.

15. The device of claim 12 wherein the first processor is further configured to write a physical address of flash memory, a data size, a designated address of the shared memory area into which read data will enter, and a read command to the first mailbox area.

16. The device of claim 15 wherein the second processor is configured to acquire a use priority associated with the shared memory area, said second processor accessing the first mailbox area to read data from the physical address of the flash memory, said second processor further configured to write the read-data to the designated address of the shared memory area.

17. The device of claim 12 wherein the first processor is configured to write write-data to the shared memory area, said first processor writing a logical address of the flash memory, a data size, an address of the shared memory area where the write-data was written, and a write command to the first mailbox area.

18. The device of claim 17, wherein the second processor is configured to acquire a use priority associated with the shared memory area, said second processor further configured to access the first mailbox area to read the write data from the shared memory area, said second processor searches for a physical address corresponding to the logical address of the flash memory from address map data stored in the shared memory area, said second processor writing the write data to the flash memory.

19. The device of claim 12 wherein the first processor writes a logical address of the flash memory, a data size, a designated address of the shared memory area into which read data will enter, and a read command to the first mailbox area.

20. The device of claim 19 wherein the second processor is configured to acquire a use priority for the shared memory area and subsequently reading the first mailbox area to search for a physical address corresponding to the logical address of the flash memory from the shared memory area, said second processor further configured to read data from the flash memory and writing the read data to the designated address of the shared memory area.

21. A drive method of a semiconductor memory device which includes a shared memory area and an internal register each accessible to first and second processors, the method comprising:
storing address map data associated with a flash memory in the shared memory area; and
operationally connecting the shared memory area to one of the first and second processors such that the first processor indirectly accesses the flash memory by using the shared memory area and the internal register even when only the second processor is coupled to the flash memory.

22. A method of writing data to a flash memory through a semiconductor memory device which includes a shared memory area of a memory cell array and an internal register each accessible to first and second processors, the method comprising:
during an initial booting of a system having the flash memory, allowing the second processor to load address map data associated with the flash memory to the shared memory area from the second processor;
allowing the first process to write write-data to the shared memory area from the first processor;
allowing the first processor to write a physical address of the flash memory, a data size, a designated address of the shared memory area where the write-data was written, and a write command to a transmission mailbox area included in the mailbox areas;
allowing the second processor to access the transmission mailbox area to read the write-data from the designated address of the shared memory area; and
allowing the second processor to write the write-data to the physical address of the read flash memory.

23. A mobile communication system comprising:
a first processor for performing a first determined task;
a second processor for performing a second determined task;
a flash memory coupled to the second processor; and
an integrated dynamic random access memory including a shared memory area, an internal register and a control unit, the shared memory area being accessed by the first and second processors through different ports and allocated to a portion of a memory cell array, the internal register being located outside the memory cell array and accessed by the first and second processors, the control unit storing address map data of the flash memory in the shared memory area such that the first processor indirectly accesses the flash memory by using the shared memory area and the internal register, said control unit configured to control a communication path to operationally connect the shared memory area to one of the first and second processors.
